(19) United States
(12) Patent Application Publication
(10) Pub. No.: US 2006/0282338 A1
(43) Pub. Date: Dec. 14, 2006

(54) Method of providing a soft toy

(76) Inventor: Neil Francis Cope, Queensciff (AU)

Correspondence Address: DRINKER BIDDLE & REATH (DC), 1500 K STREET, N.W., SUITE 1100, WASHINGTON, DC, 20005-1209, US

(21) Appl. No.: 11/494,760

(22) Filed: Jul. 28, 2006

(51) Int. Cl. G06Q 30/00; A63H 3/02

(52) U.S. Cl. 705/26; 446/369

(57) ABSTRACT

A method of providing a soft toy, includes forming with a textile fabric a first subassembly, personalizing a second subassembly, and connecting together the first and second subassemblies. The first subassembly is a body that defines a first aperture, and the connecting includes the second subassembly occluding the first aperture.

### FIELD OF THE INVENTION

The invention relates to toys made with a textile fabric, and which are commonly known as “stuffed animals,” “soft toys,” “plush toys” or “plushies.” In particular, the invention relates to a method of providing such toys.

### BACKGROUND OF THE INVENTION

The term “stuffed animal” conventionally refers to a toy simulation of an animal, with straw, beans, cotton or other similar materials used to stuff a skin. Historically, the skin of the stuffed animal may have been an evacuated skin of a hunted animal, and the phrase “stuffed animal” is still sometimes used to refer to examples of taxidermy. However, it is now conventional to produce the skins of toy animals with textile materials, including natural or synthetic fibers, and it is for this reason that “soft toy” or “plush toy” may be a more appropriate name for a modern stuffed animal.

There is almost no limit to the species of animal that may be simulated by a soft toy. An example of a popular type of classic stuffed animal is a teddy bear. Conventionally, a teddy bear is an unjointed bear where arms, head and legs are stitched to the body. However, teddy bears are also known to be fully jointed, which means that the arms, legs or head are movable by being attached to a body with disks or cotter pins.

### SUMMARY OF THE INVENTION

The invention encompasses a method of providing a soft toy. The method includes forming with a textile fabric a first subassembly, personalizing a second subassembly, and connecting together the first and second subassemblies. The first subassembly is a body that defines an aperture, and the connecting includes the second subassembly occluding the aperture.

The invention further encompasses a method of providing a soft toy, which includes forming with a textile fabric a first subassembly, personalizing a second subassembly, and connecting together the first and second subassemblies. The first subassembly simulates a body of an animal with an aperture disposed at a location corresponding to a paw of the animal. The personalizing includes embroidering on a panel at least one of a name of a person and a statistic of the person. And the connecting includes the embroidered panel of the second subassembly occluding the aperture of the first subassembly.

The invention further encompasses a method of providing a soft toy, which includes forming with a textile fabric a first subassembly, storing the first subassembly for between one week and six months, personalizing a second subassembly, connecting together the first and second subassemblies within one week of personalizing the second subassembly, inverting the body, supplying stuffing into the body through an opening, closing the opening, and embroidering features on the body.

The invention further encompasses a method of providing a soft toy, which includes forming with a textile fabric a first subassembly, receiving a customer order at a first location, transferring from the first location instructions in accordance with the customer order for personalizing a second subassembly, and connecting together the first and second subassemblies. The personalizing and connecting occur at a second location that is at least one kilometer from the first location.

### BRIEF DESCRIPTION OF THE DRAWINGS

The accompanying drawings, which are incorporated herein and constitute part of this specification, illustrate preferred embodiments of the invention, and together with the general description given above and the detailed description given below, serve to explain features of the invention.

FIG. 1 is a perspective view of a soft toy according to a first embodiment of the present invention.

FIG. 2A is a plan view of a subassembly for the soft toy illustrated in FIG. 1.

FIG. 2B is a plan view of another subassembly for the soft toy illustrated in FIG. 1.

FIG. 3A is a plan view of a one-piece panel for a soft toy according to one construction technique for the present invention.

FIG. 3B is a perspective view of a soft toy in partially assembled form constructed from a panel as illustrated in FIG. 3A.

FIG. 4A is a plan view of a one-piece panel for a body portion of a soft toy according to another construction technique for the present invention.

FIG. 4b is a portion of a soft toy in assembled form constructed from the panel illustrated in FIG. 4A.

FIG. 5A is a plan view of a one-piece panel for forming a head portion of a soft toy in accordance with the construction technique illustrated in FIGS. 4A and 4B.

FIG. 5B is a perspective view of a head portion of a soft toy in assembled form constructed using the panel shown in FIG. 5A.

FIG. 6A is a plan view of an alternative one-piece panel for forming a head portion of a soft toy in accordance with the construction technique illustrated in FIGS. 4A and 4B.

FIG. 6B is a perspective view of a head portion of a soft toy in assembled form constructed using the panel shown in FIG. 6A.

FIG. 7A is a plan view of a one-piece panel for forming a leg portion of a soft toy according to another construction technique for the present invention.

FIG. 7B is a perspective view of a leg portion of a soft toy in assembled form constructed using the panel shown in FIG. 7A.

FIG. 8 is a chart illustrating a sequence for providing a soft toy according to the present invention.

### DETAILED DESCRIPTION OF THE PREFERRED EMBODIMENTS

As it is used herein, “plush” or “plush material” refers to a textile fabric having a cut nap or pile similar to velvet, which frequently has a shorter and more dense pile. Modern plush, as it is used to make plush animals, is commonly manufactured from synthetic fibers such as polyester. Alternatively, the pile of plush may include, for example, mohair, worsted yarn, or silk by itself or with a cotton backing.

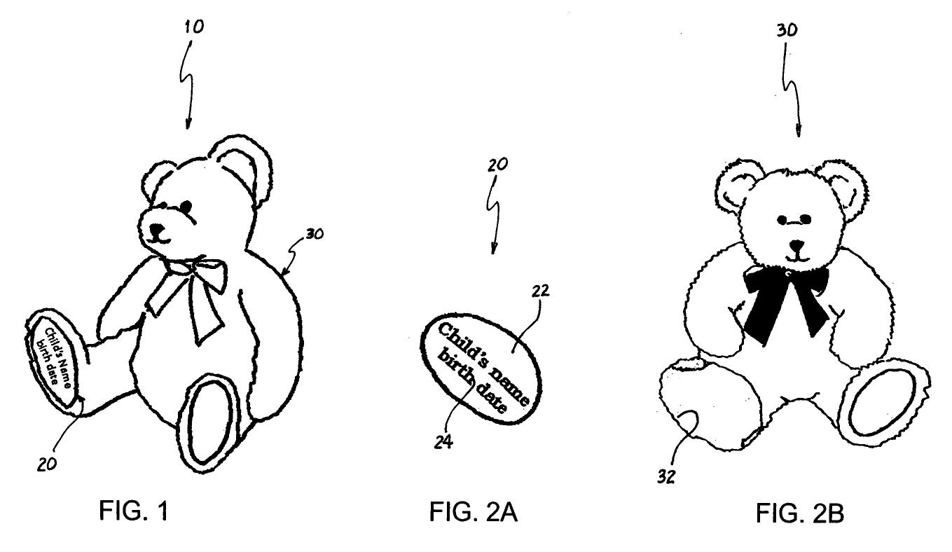

FIG. 1 shows a soft toy 10 of the type generally known as a “teddy” bear including embroidering that personalizes the soft toy 10. According to the present invention, a separately formed subassembly 20 includes a panel 22 upon which personalizing indicia 24 is applied. The remainder of the soft toy 10 is separately formed as another subassembly 30, which defines an aperture 32 that is subsequently occluded by the subassembly 20. Then, according to the present invention, the two subassemblies 20,30 are connected to complete the assembly of the soft toy 10.

Referring additionally to FIGS. 2A and 2B, the subassemblies 20 and 30 are shown, respectively. Subassembly 20 includes personalizing indicia 24 such as the name and birthdate of a person. With such indicia 24, the soft toy 10 is particularly suited as a birthday gift for a newborn, a youth, or an adult. Of course, the panel 22 may be alternatively or additionally be labeled with any type of personalizing indicia including, for example, names of schools or events, dates of graduation or marriage, age, etc. The manner of applying the personalizing indicia 24 is preferrably by embroidering, but may alternatively or additionally include printing, embossing, or other known labeling techniques. The panel 22, which may be made of any textile fabric, is preferrably a suede-like plush that includes polyester fibers.

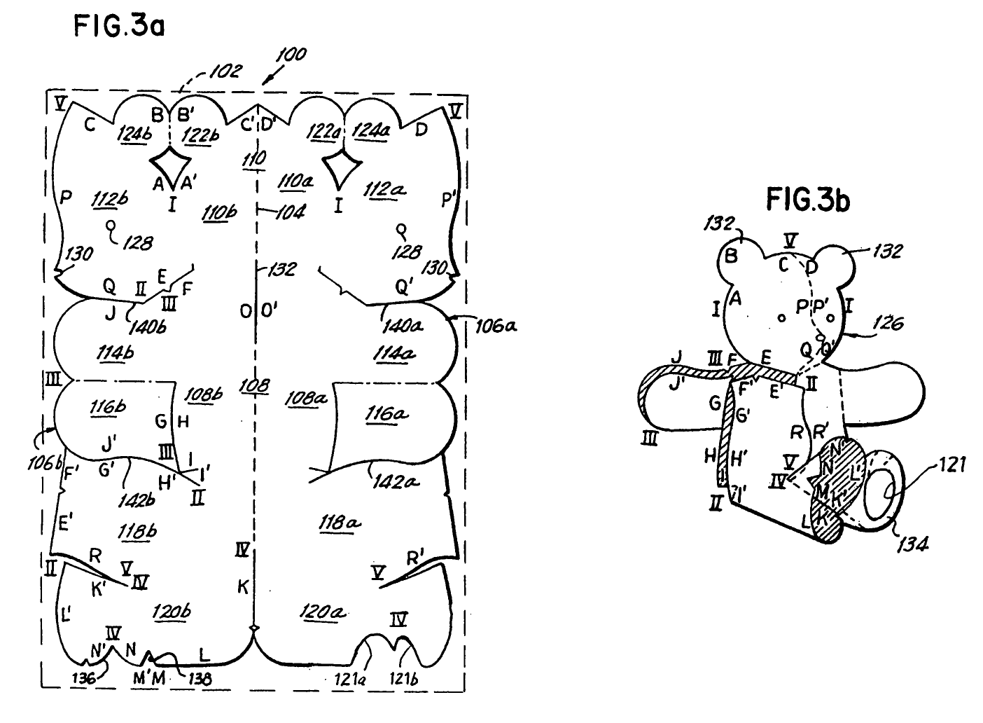

With particular reference to FIG. 2B, subassembly 30 includes the majority of the soft toy 10 and may also be made of any textile fabric, but is preferrably an 18 millimeter super soft curly plush including polyester fibers. The general construction of the subassembly 30 can be accomplished by a number of techniques; several of which are described hereinafter in connection with FIGS. 3A-7B. However, regardless of the construction technique that is used, the subassembly 30 defines an aperture 32. The aperture 32 and the subassembly 20 are correspondingly sized and shaped such that the subassembly 20, after the personalizing indicia 24 is applied to the panel 22, is connected to the subassembly 30 so as to occlude the aperture 32.

Referring now to FIGS. 3A-7B, a variety of construction techniques for forming the subassembly 30 are illustrated by including a plan view of a “panel” and another view showing the soft toy constructed therefrom in assembled or partially assembled form. In each case, the upper case letters found on each of the drawings indicates the manner in which the panel is to be folded to obtain the constructed soft toy. More particularly, each upper case letter associated with a plan view of a panel is one of a pair, including an upper case letter and the same uppercase letter, primed (for example, A and A′). In each case, those portions of a panel designated by a pair of letters are to be brought together into mating relationship during the construction of the soft toy. Thus, for example, that portion of a panel marked A is brought into mating contact with the corresponding portion of the panel marked A′.

Each of the illustrations also has associated therewith several sets of Roman numerals. Each set of such Roman numerals indicates that a separate seam is to be provided on the mating edges of the panel defined between these Roman numerals. Thus, for example, a seam is provided at the mating edges of the panel extending between the Roman numerals I.

Additionally, in the description of the actual construction of a soft toy from a panel, when reference is made to “folding” the panel, it is to be understood that a fabric panel is not folded in the sense that a piece of paper is folded with a crease being formed along a so-called fold line. Instead, when reference is made to “folding” the panel with respect to a designated “fold line,” it is understood that the fabric is merely being manipulated in the usual sense with respect to a particular reference point, without forming any creases or the like.

Finally, in the plan view of the panels, solid lines represent actual edges of the panel cut, e.g. by a die, dashed lines are imaginary reference lines and dash-dot lines are “fold lines” within the meaning discussed immediately hereinabove.

Turning now to the construction technique illustrated by FIGS. 3A and 3B, a one-piece textile fabric panel, generally denoted as 100 is illustrated, for constructing a soft toy 126 in the form of a “teddy” bear. As can be seen, the outermost edge of panel 100 lies close to the edge of a rectangular area denoted by dotted line 102. In this sense textile fabric panel 100 has a substantially rectangular configuration, which may result in a reduction in wasted material.

An imaginary median line 104 longitudinally bisects panel 100 into right and left halve portions 106a,b respectively, which are substantially mirror images of each other. The use of mirror image panels is generally common to the different construction techniques.

The panel includes a rear body-forming portion 108 which median line 104 bisects into right and left rear body-forming sub-portions 108a,b. Extending upwardly from and integral with rear body-forming portion 108 is rear head-forming portion 110, which median line 104 bisects into right and left rear head-forming sub-portions 110a,b. Laterally extending from and integral with right and left rear head-forming sub-portions 110a,b, are right and left front head-forming portions 112a,b, respectively. Extending laterally from right and left rear body-forming sub-portions 108a,b are right and left rear arm-forming portions 114a,b, respectively. Similarly, extending downwardly from and integral with the right and left rear arm-forming portions 114a,b are right and left front arm-forming portions 116a,b, respectively.

Integral with and extending from right and left rear body-forming sub-portions 108a,b are right and left front body-forming portions 118a,b, respectively. Right and left leg-forming portions 120a,b extend from and are integral with right and left front body-forming portions 118a,b, respectively.

Disposed on the right leg-forming portion 120a are cutouts 121a, 121b, which define the aperture 32 when the one-piece panel 100 is formed into the soft toy 126. A complete left-foot is integral with the left leg-forming portion 120b. According to the present invention, and as shown in FIG. 3B, the aperture 32 is occluded by the subassembly 20 after the personalizing indicia 24 is applied to the panel 22. Although the aperture 32 that is formed by the one-piece panel 100 results in the subassembly 20 being disposed at a location corresponding to the right rear paw of the soft toy 126, an aperture could alternatively be disposed at other locations on the soft toy 126. Preferably, an aperture and hence the subassembly 20 are disposed at a location that corresponds to an extremity such as a paw, a hand, a foot, an ear, or a tail.

Finally, right and left rear ear-forming portions 122a,b, are integrally formed with and extend from right and left rear head-forming sub-portions 110a,b, respectively, while right and left front ear-forming portions 124a,b are integral with and extend from right and left front head-forming portions 112a,b, respectively, the former being integral with right and left rear ear-forming portions 122a,b.

One-piece panel 100, when folded according to the letter indicia marked on FIG. 3A described hereinabove, forms the stuffed animal, 126, shown in FIG. 3B in its entirely. A minimum number of seams are required subsequent to bringing corresponding portions of panel 100 into abutting relationship with the edges there of in mating position.

Openings 128 and notches 130 are provided in the front head-forming portions 112 to provide means to which eye and nose members respectively, can be connected to the soft toy 126. Further, a cut 132 is provided along median line 104 to provide access to the interior of soft toy 126 subsequent to seaming and inverting, i.e., turning the constructed skin inside out for supplying stuffing material, e.g., polyester, through an opening in the skin.

In the present case, the ears 132 of stuffed animal 126 are intended to be formed of the same material as the remainder of the animal and, accordingly, ear-forming portions 122,124 are provided integrally with panel 100. The material of the subassemblies 20 and 30 may be the same, but are preferrably different materials.

The embodiment of the invention shown in FIGS. 3A and 3B comprises a design for forming a soft toy 126 which is advantageous insofar as it provides efficient use of material from which panel 100 is cut. More particularly, referring to right and left leg-forming portions 120a,b (FIG. 3A), and with further reference to FIG. 3B, it is noted that each such leg-forming portion, by itself, forms a corresponding leg 134 on stuffed animal 126. It is noted, however, that each leg-forming portion 120 is not symmetrical, but rather, is irregularly shaped. Applicant has found that by providing appropriately spaced notches 136,138, that the material from which panel 100 is formed may be misshapen and appropriately folded to provide a leg portion which is suitable for the particular toy with which it is employed. This so-called “shape-reconstitution design” allows for both efficient use of the material and a wide variety of possible configurations for the soft toy.

It is again noted that the edges of various adjacent portions of the panel are formed by single cuts in the material producing a sort of jig-saw puzzle relationship between these portions at these edges. For example, edges of the front head-forming portions 112 and rear arm-forming portions 114 are defined by a single cut. Similarly, the edges of front arm-forming portions 116 and front body-forming portions 118 are formed by a single cut. The cuts are shown at 140a,b and 142a,b. As mentioned hereinabove, this feature of the present invention wherein various parts of the panel are formed by a single cut of the die results in a compactness and efficient use of the panel.

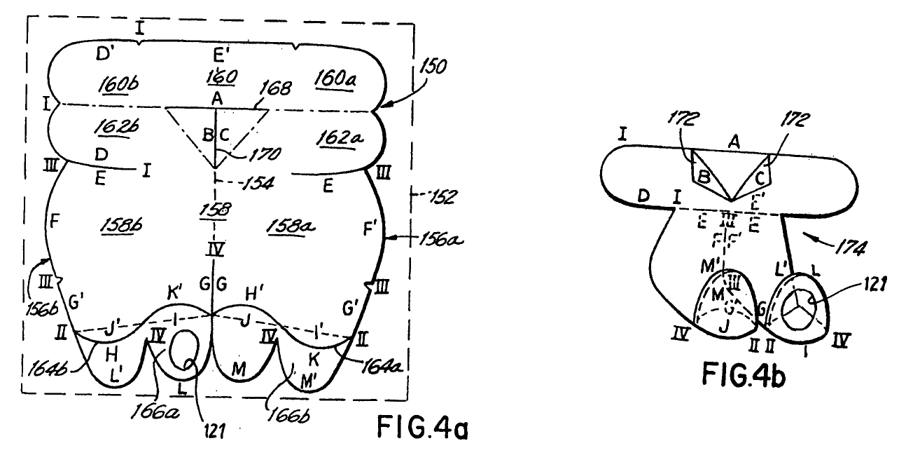

Referring now to FIGS. 4A and 4B, which illustrate another construction technique, a one-piece panel 150 is illustrated which, when folded as shown in FIG. 4B, forms only the body portion of a “teddy” bear type soft toy, i.e., the head portion is formed from a different panel. As seen in FIG. 4A, panel 150 is substantially rectangularly shaped as illustrated by dotted line 152, which represents the piece of textile fabric from which panel 150 is cut. An imaginary median line 154 extends longitudinally across panel 150 dividing the same into respective right and left halve portions 156a,b. As in the case of the other construction techniques, halve portions 156a,b, are substantial mirror images of each other.

Panel 150 includes a body-forming portion 158 and, extending upwardly from and integrally therewith rear arm-forming portion 160. Median line 154 bisects body-forming portion 158 and rear arm-forming portion 160 into right and left body-forming sub-portions 158a,b and right and left rear arm-forming sub-portions 160a,b. Integrally extending from right and left body-forming sub-portions 158a,b and also integral with right and left arm-forming sub-portions 160a,b, are right and left front arm-forming portions 162a,b, respectively.

In forming soft toys wherein the terminal portion of the legs are intended to extend upwardly when the soft toy is in a sitting position, such as a soft toy constructed using the body illustrated in FIG. 4B, and where these terminal portions are to be of any desired length, it has discovered that this may be efficiently accomplished by a pair of die cuts 164a,b, each having a substantially sinusoidal configuration. More particularly, right and left leg-forming portions 166a,b are defined by die cuts 164b,a, respectively. It is noted that the right leg-forming portion 166a is formed on the left side of the panel while the left leg-forming portion 166b is formed on the right side. In the construction of the soft toy, described below, these leg-forming portions are reversed with respect to median line 154 and are attached to the appropriate edges of the front body-forming portions 158a,b as denoted by the upper case letter indicia described above. This technique may be referred to as “exchange of areas.”

Disposed on the left leg-forming portion 166b is a cutout 121, which defines the aperture 32 when the one-piece panel 150 is formed into the soft toy 174. A complete right-foot is integral with the right leg-forming portion 166a. According to the present invention, and as shown in FIG. 4B, the aperture 32 is occluded by the subassembly 20 after the personalizing indicia 24 is applied to the panel 22. Thus, in contrast to the location of the aperture 32 on the right leg-forming portion 120a that is formed by the one-piece panel 100 in FIGS. 3A and 3B, FIGS. 4A and 4B show the aperture 32 being disposed at an alternate location that corresponds to the left rear paw of the soft toy 174.

A T-shaped pair of die cuts 168,170 are formed in panel 150, the former being centrally provided along the fold line between front and rear arm-forming portions 160,162 and the latter being provided along median line 154. Upon construction of the soft toy, cuts 168,170 define a pair of flaps 172 (FIG. 4B) for attaching a head portion of the soft toy. These flaps thus define an “inner neck opening.”

It is again noted that pattern 150 is extremely compact and includes a minimum of wasted material due, at least in part, to the fact that single die cuts define edge portions of various parts of panel 150. More particularly, a single die cut defines edge portions of right and left front arm-forming portions 162a,b and right and left body-forming portions 158a,b, respectively. Further, single cuts define edge portions of right and left body-forming portions 158a,b and left and right leg-forming portions 166b,a, respectively.

Panel 150 is “folded” according to the upper case letter indicia in the manner described hereinabove with respect to the various construction techniques. The folded panel is then seamed according to the Roman numeral indicia marked thereon, turned inside out and supplied with stuffing material.

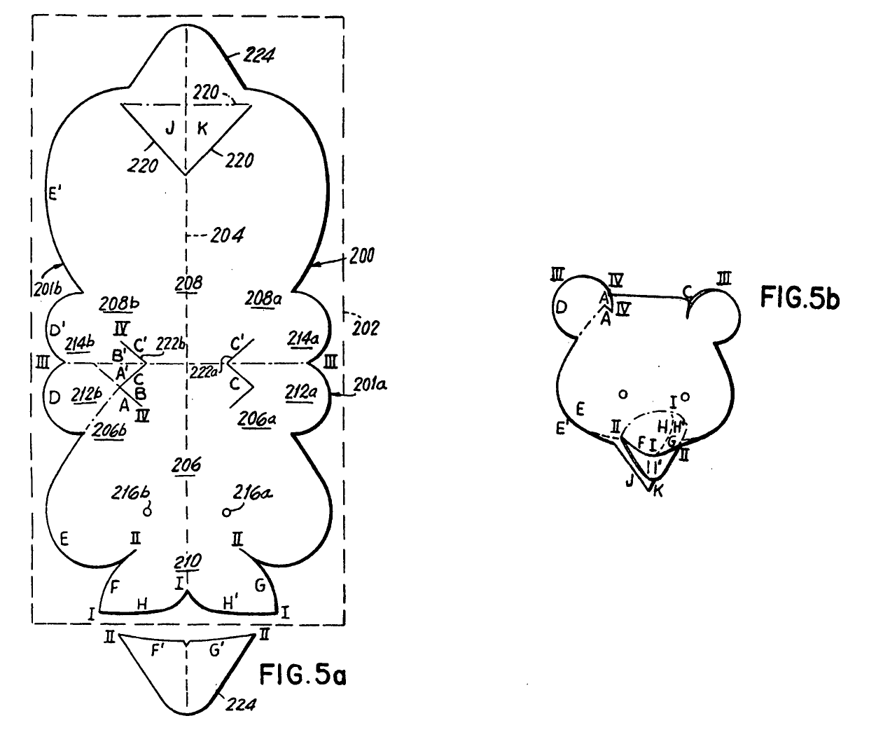

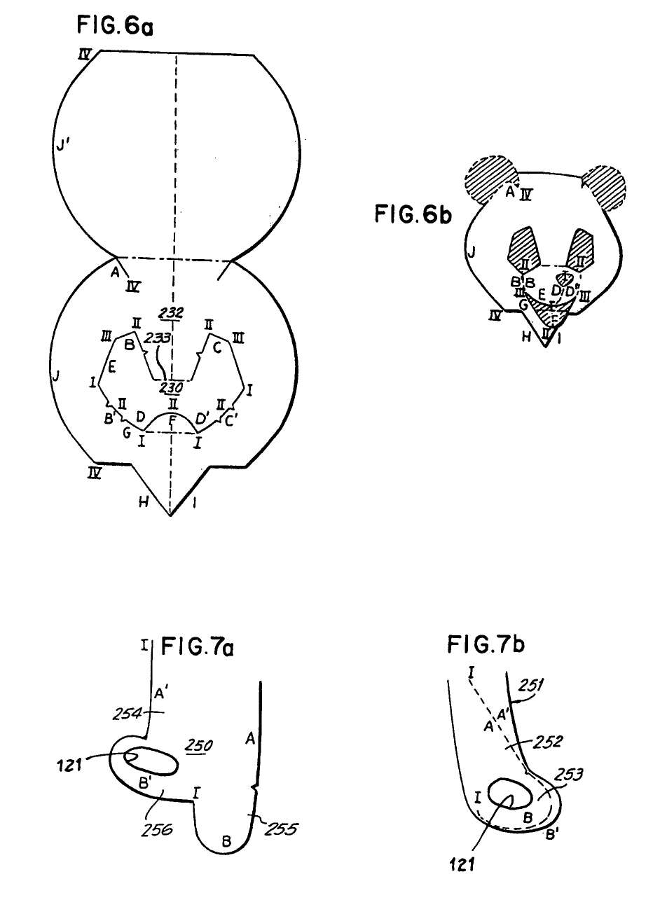

Turning now to FIGS. 5A-6B, one-piece panels are illustrated for forming the heads of three dimensional soft toys, which heads are particularly adapted to be used with bodies formed, for example, as shown in FIG. 4. It is understood, however, that the heads formed by the panels shown in FIGS. 5A-6B can be used with a body formed using the principles of this invention or, alternatively using other known techniques.

Referring to FIGS. 5A and 5B, a one-piece panel 200 has a substantially rectangular configuration as shown by dotted line 202. An imaginary median line 204 bisects panel 200 into right and left halve portions 201a,b. A front head-forming portion 206 is integral with and extends from rear head-forming portion 208. Downwardly extending from and integral with front head-forming portion 206 is nose-forming portion 210. Front and rear left ear-forming portions 212b,214b are integrally connected, the front left ear-forming portion 212b being integral with and extending from the left front head-forming portion 206b. Similarly, front and rear right ear-forming portions 212a,214a are integral with each other, the front right ear-forming portion 212a extending from and being integral with the right front head-forming portion 206a. The right rear ear-forming portion 212a, extends from and is integral with the right rear head-forming portions 208a.

A pair of cuts 220 are formed in the rear head-forming portion 208a, as seen in FIG. 5A, to provide a neck connecting opening as explained below. Further, right and left zigzag cuts 222a,b extend across front and rear head-forming portions 206,208 as shown.

The head is formed by following the same procedure with respect to the other construction techniques. Thus, referring to FIGS. 5A and 5B, the panel is folded so that corresponding plain and primed uppercase letters are brought into mating relationship. A second panel 224 is utilized in a similar manner in forming the nose, i.e., panel 224 is connected to corresponding parts in panel 200 as is indicated by the letter indicia. Cuts 222 form flaps which are folded upwardly and cooperate with ear-forming portions 212,214 to form the ears. Small openings 216 are formed in front head forming portions 206 to provided means for connecting eye members to the head.

Again, it is seen that a relatively small number of seams are required to sew the head together, the seams being denoted by the Roman numerals in FIGS. 5A and 5B. The cuts 220 formed in rear head-forming portion 208 provide a flap which is folded downwardly along fold line 226 thereby providing an opening adapted to be connected to the inner neck opening in a previously formed soft toy body, such as that described in connection with FIGS. 4A and 4B.

Referring to FIGS. 6A and 6B, another one-piece panel similar to that shown in FIG. 5A is shown for forming a head of a soft toy. In this case, the head is adapted for use in a panda type toy which, as known in the art, includes eye and ear areas formed of different type materials than is used for forming the head itself. To facilitate the provisions of at least the eye areas as well as to form the nose or snout of the head, an area 230 is defined which is to be partially cut from the panel and outwardly folded therefrom along fold line 233. Area 230 is folded as indicated by the upper case lettering associated with it forming the snout as seen in FIG. 6B as well as the areas for eye materials. Again, the same uppercase letter indicia is used to illustrate the procedure in folding the panel shown in FIG. 6A to achieve the head shown in FIG. 6B. It is believed that the drawings and accompanying indicia will be readily understood by one skilled in the art to accomplish this fold operation.

The panel 250 illustrated in FIG. 7A is illustrative of the manner in which the fabric can be “folded” while distorting the outer perimeter thereof to achieve a desired shape. This is described hereinabove as “shape-reconstitution design” in connection with FIGS. 3A and 3B. The particular panel shown in FIG. 7A is used in the construction of the leg portion of a soft toy. It is seen that the panel itself is not symetrically formed. However, upon appropriately “folding” the panel as indicated by the upper case indicia while bringing the corresponding edge portions thereof into mating relationship with corresponding edge portions, as shown in FIG. 7B, the leg portion is formed. In general, such panel sections are used in forming limbs of soft toys which include a main member and a terminal member which extends at an angle to the main member. Thus, referring to FIGS. 7A and 7B, panel 250 is used in forming limb 251 which includes a main member 252 and terminal member 253. Panel 250 includes a main member forming portion 254, a first terminal member forming portion 255, and a second terminal member forming portion 266. The characteristic of the “shape reconstitution process” is that the first and second terminal member forming portions extend at a calculated angle from each other. The terminal portion formed by the terminal members extends from the main member at an angle determined by the calculated angles. Thus, as seen in FIGS. 7A and 7B, a 90 degree angle between the terminal member forming portion will bring about a 45 degree angle on the finished product in this particular case.

Disposed on panel 250 is a cutout 121, which defines the aperture 32 when the panel 250 is formed into the limb 251. Again, according to the present invention, and as shown in FIG. 7B, the aperture 32 is occluded by the subassembly 20 after the personalizing indicia 24 is applied to the panel 22. Thus, the location of the aperture 32 on the limb 251 in FIG. 7B that is formed by the panel 250 in FIG. 7A, illustrates that the aperture 32 may be disposed on any extremity that is subsequently connected to a body of a soft toy.

Of course, each and every soft toy portion, e.g., torso, head, arms, legs, ears, snout, etc., may be formed by two or more panels that are cut to the appropriate shape and then sewn together. Thereafter, the portions may be sewn together to form the first subassembly according to the present invention. Thus, a plurality of panels may be used to form the first subassembly. According to one preferred embodiment of a “teddy” bear, there are 24 panels in total, which includes four paw panels. According to this preferred embodiment, a torso portion has two panels that are stitched together at one time; each of the two arm portions has two panels plus a paw panel, which are all stitched together and then attached to the body; a head portion has five panels that are all stitched together, including two at the rear of the head portion and three at the front of the head portion; a snout portion has three panels that are stitched together, and then stitched to the head portion; the two leg portions have two panels plus a paw panel for each leg (of course, according to the present invention, only one of the leg portions has the paw panel attached during the construction of subassembly 30); and each of two ear portions has two panels that are stitched together with three of the head portion panels.

According to the invention, it is preferable that the panels are made of textile fabrics, and that sewing is used to connect the various panels, subassemblies and other features. However, connections may alternatively or additionally be formed by adhering, bonding or other known connectors suitable for the materials being connected.

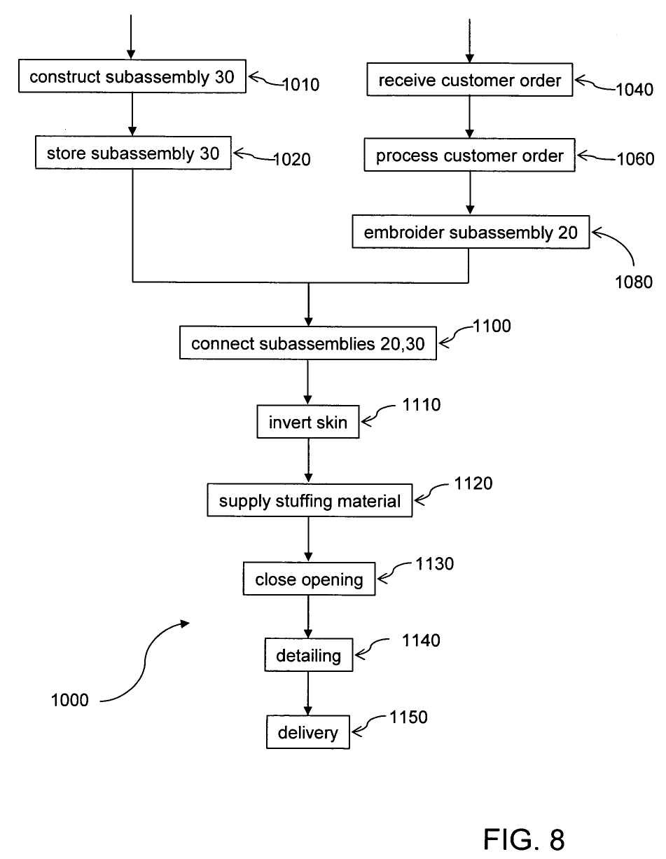

Referring now to FIG. 8, there is shown a flow chart illustrating a preferred sequence 1000 of steps for providing a soft toy according to the present invention. The subassembly 30 may be constructed 1010 and may be stored 1020 in advance of a customer order being received 1040. Preferably, the customer order, which may be received, e.g., via the internet, by facsimile, by telephone or by postal mail, specifies the personalizing indicia 24. Processing 1060 of the customer order may include transferring instructions to a machine for embrodering 1080 the the specific personalizing indicia 24. The instructions may be machine code that is transferred directly to an automated machine for the embrodering 1080 of a panel 22. The subassembly 20 that results from the embroidering 1080 is connected 1100 with a subassembly 30 that may have been stored 1020, perhaps for one week to six months. In particular, the connecting 1100 includes the second subassembly 20 occluding the aperture that was defined during the construction 1010 of the subassembly 30. Thereupon, assembly of the skin of the soft toy 10 is substantially complete, and the skin is inverted 1110 and supplied 1120 with stuffing material via an opening in the skin. The opening is then closed 1130 and detailing 1140 may be added to the soft toy 10. Examples of the detailing 1140 may include embroidering features such as a mouth or nostrils, adding decorations such as a bow or a collar, etc. Finally, the soft toy 10 is ready for delivery 1150 in accordance with the customer order.

Preferably, the embroidering 1080 of the subassembly 20 is completed within one week of the customer order being received 1040, and in any event in a time period that is less than the time period that the subassembly 30 is stored 1020. Thus, a stock of subassemblies 30 may be accumulated in anticipation of the customer orders being received 1040 and processed 1060. Also, it may be preferable for the subassemblies 20,30 may be constructed 1020 and embroidered 1080 at a location that is remote, e.g., more than one kilometer, from a location at which the customer order is received 1040 and processed 1060. For example, the construction 1020 and embroidering 1080 may be performed in a separate country from which the customer orders are received 1040 and processed 1060. Finally, the delivery 1150 may occur directly from the location performing the construction 1020 and embroidering 1080, or may include shipping back to the location at which the customer order was received 1040 and processed 1060.

A feature of the invention is that a personalized portion of a soft toy is subsequently connected to complete the skin of the soft toy, rather than personalization being applied to a previously completed skin for a soft toy.

Another feature of the invention is that the manufacture of a skin for a soft toy is separated into two subassemblies, including a personalizing subassembly and a body subassembly. And the two subassemblies are connected together at approximately the time the personalized subassembly is completed, which is independent of when the body subassembly is completed.

Another feature of the invention is that the personalizing subassembly may be generally standardized, whereas the body subassembly may be varied in accordance with a particular construction technique that is to be implemented or with the species of animal that is being simulated by a soft toy.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

What is claimed is:

1. A method of providing a soft toy, comprising:
forming with a textile fabric a first subassembly as a body defining an aperture;
personalizing a second subassembly; and
connecting together the first and second subassemblies, the connecting including the second subassembly occluding the aperture.

2. The method according to claim 1, wherein the forming comprises:
cutting according to a pattern at least one panel of the textile fabric.

3. The method according to claim 2, wherein the pattern corresponds to a shape simulating at least a portion of an animal.

4. The method according to claim 2, wherein the textile fabric comprises a curly plush including polyester fibers.

5. The method according to claim 2, wherein the at least one panel comprises a plurality of panels.

6. The method according to claim 5, wherein the forming comprises:
connecting an edge of a first one of the plurality of panels to an edge of a second one of the plurality of panels; and
defining a pocket between the first and second ones of the plurality of panels.

7. The method according to claim 6, wherein the connecting comprises at least one of sewing, adhering and bonding.

8. The method according to claim 6, further comprising:
supplying stuffing into the pocket.

9. The method according to claim 2, wherein the forming comprises:
connecting together edges of the at least one panel so as to define a pocket between layers of the at least one panel.

10. The method according to claim 9, wherein the connecting comprises at least one of sewing, adhering and bonding.

11. The method according to claim 9, further comprising:
supplying stuffing into the pocket.

12. The method according to claim 11, wherein the stuffing comprises polyester.

13. The method according to claim 1, wherein the aperture is disposed on an extremity of the body.

14. The method according to claim 13, wherein the extremity comprises at least one of a paw, a hand, a foot, an ear, and a tail.

15. The method according to claim 1, wherein the body simulates an animal and the aperture is disposed at a location corresponding to a paw of the animal.

16. The method according to claim 1, wherein the personalizing comprises labeling with indicia an occluding panel.

17. The method according to claim 16, wherein the labeling comprises embroidering.

18. The method according to claim 16, wherein the indicia comprises at least one of a name of a person and a statistic of the person.

19. The method according to claim 16, wherein the occluding panel comprises a textile fabric different from the body.

20. The method according to claim 19, wherein the textile fabric of the occluding panel comprises a suede-like plush including polyester fibers.

21. The method according to claim 1, wherein the connecting together the first and second subassemblies comprises at least one of sewing, adhering and bonding.

22. The method according to claim 1, further comprising:
inverting the body, the inverting occurring after the connecting together the first and second subassemblies.

23. The method according to claim 22, further comprising:
supplying stuffing into the body through an opening, the supplying occurring after the inverting the body; and
closing the opening, the closing occurring after the supplying stuffing.

24. The method according to claim 23, further comprising:
detailing the body, the detailing occurring after the supplying stuffing.

25. The method according to claim 24, wherein the detailing comprises embroidering features on the body.

26. The method according to claim 1, further comprising:
storing the first subassembly for a first period of time prior to the connecting together the first and second subassemblies.

27. The method according to claim 26, wherein the first period of time comprises a range between one week and six months.

28. The method according to claim 26, wherein the personalizing the second subassembly occurs a second period of time prior to the connecting together the first and second subassemblies, and the second period of time is less than the first period of time.

29. The method according to claim 28, wherein the second period of time comprises a range up to one week.

30. The method according to claim 1, wherein the personalizing occurs in response to processing a customer order.

31. The method according to claim 30, wherein the processing comprises receiving the customer order via at least one of an internet communication, a telephone communication, a facsimile communication, and a postal mail communication.

32. The method according to claim 31, wherein the receiving occurs at a first location, the personalizing comprises labeling with indicia in accordance with the customer order, and the labeling occurs at a second location a distance from the first location.

33. The method according to claim 32, wherein the distance comprises at least one kilometer, and the personalizing comprises transferring between the first and second locations instructions for the labeling.
